(19) United States
(12) Patent Application Publication
(10) Pub. No.: US 2026/0209110 A1
(43) Pub. Date: Jul. 23, 2026

(54) METHOD FOR PRODUCING POWDER COMPOSITION FOR CERAMIC COATING AND ITS USE

(71) Applicant: TEKNOLOGIAN TUTKIMUSKESKUS VTT OY, Espoo (FI)

(72) Inventors: Kimmo KAUNISTO, Espoo (FI); Juha LAGERBOM, Espoo (FI); Päiv KIVIKYTÖ-REPONEN, Espoo (FI)

(73) Assignee: TEKNOLOGIAN TUTKIMUSKESKUS VTT OY, Espoo (FI)

(21) Appl. No.: 19/140,744

(22) PCT Filed: Dec. 20, 2023
(86) PCT No.: PCT/FI2023/050719

§ 371 Date: Jun. 18, 2025

(30) Foreign Application Priority Data
Dec. 23, 2022 (FI) 20226162

(51) Int. Cl. C03C 12/00; C03C 8/02; C03C 10/00; C23C 4/11

(52) U.S. Cl. CPC C03C 12/00; C03C 8/02; C03C 10/00; C23C 4/11; C03C 2207/04

(57) ABSTRACT

The present disclosure relates to a method for producing a powder composition suitable for use in the preparation of an alumina based ceramic coating. More particularly the disclosure relates to preparing the powder composition by heat treating a mixture of primary particles agglomerates, wherein the mixture of primary particles consists of between 35 and 60 mol-% cations and between 40 and 65 mol-% anions and the cations comprises between 1:3 and 1:40 of the total sum of Ca- and Si-ions (mol-%): Al-ions (mol-%). The mixture typically comprises Ca-ions (mol-%): Si-ions (mol-%) in a ratio of 1:2.5-2.5:1. The disclosure further relates to a powder composition obtained by the method of the disclosure and the use of the powder composition in thermal spraying to form a glass ceramic coating and the use of the powder composition for forming a glass ceramic structure in-situ in thermal spray deposition.

### FIELD OF THE DISCLOSURE

The present disclosure relates to a method for producing a powder composition suitable for use in the preparation of an alumina based ceramic coating. More particularly the disclosure relates to preparing the powder composition by heat treating a mixture of primary particles agglomerates, wherein the mixture of primary particles consists of cations and anions, preferably oxygen and wherein the cations comprise between 1:3 and 1:40 of the total sum of Ca- and Si-ions (mol-%): Al-ions (mol-%) and wherein the mixture typically comprises Ca-ions (mol-%): Si-ions (mol-%) in a ratio of 1:2.5-2.5:1. The disclosure further relates to a powder composition obtained by the method of the disclosure and the use of the powder composition in thermal spraying to form a glass ceramic coating and the use of the powder composition for forming a glass ceramic structure in-situ in thermal spray deposition.

### BACKGROUND OF THE DISCLOSURE

Coating technology is a fast-growing technology area, where the surface of a solid material is improved or restored by using a covering that is applied to the surface of an object, usually referred to as a substrate. Using a thin layer of substance on the surface of the substrate can resist contact forces and provide protection against material wear. Numerous materials, including metal, ceramic, polymers, and composite coatings, are rigorously used to tune the properties of different substrates. For example, paint coatings can act as a barrier that prevents an electrochemical charge transferring to the corrosive solution and a metal underneath.

There are different coating processes suitable for different applications. The classification of different coating processes typically comprises chemical and physical vapor deposition; chemical and electrochemical techniques; spraying; roll-to-roll coating; and physical coating processes.

Thermal spray coating is an industrialized process that combines a heat source with a wire or powder coating material. In thermal spray coating the material, the powder composition forming the coating, is melted, or heated into droplets and sprayed onto a surface at a high velocity. Different thermal spray powders for the manufacturing of coatings are commercially available. The process can be used to apply coatings to a wide range of materials and components, to provide resistance to wear, erosion, cavitation, corrosion, abrasion or heat and different coatings have different characteristics. For example, ceramic coatings are traditionally hard wear resistant materials, but the coatings are usually extremely brittle. Hard WC-Co coatings are more wear resistant but possess no electrical insulation properties.

Although different coatings are subject for continuous product and process innovation in the field, there is still need for improvement.

### BRIEF DESCRIPTION OF THE DISCLOSURE

An object of the present disclosure is to provide a method for preparing a glass ceramic coating powder composition, wherein the composition of the starting materials used for preparing the powder composition is selected in such way that a glass ceramic structure forms in-situ during thermal coating, typically by thermal spraying.

The object of the disclosure is achieved by a method, products and use which are characterized by what is stated in the independent claims. The preferred embodiments of the disclosure are disclosed in the dependent claims.

The disclosure is based on the idea of providing a material composition, a powder composition which is tailored to form a glass ceramic structure with desired proportions of amorphic glass phase and crystalline ceramic phase, in-situ during thermal spraying.

As the glass ceramic structure forms in-situ during thermal spraying, an advantage of the method and products of the disclosure is that no heat treatments of the coating are needed. Also, the glass phase is not pre-manufactured before the thermal spraying.

A further advantage of the disclosure is that the structure of the glass ceramic coatings provided by the method and products of the disclosure leads to improved toughness enhancing product life and/or extending service life of the coated substrate. Advantageously, by the method and products of the disclosure, coatings are provided which are developed for extreme wear, for electrical and chemical resistant applications using inexpensive raw materials. The coating of the disclosure is typically used for corrosion resistant coating materials, dielectric insulation and plungers as well as for any surfaces where abrasion resistance is needed together with chemical and electrical stability.

Typically, by using the powder composition of the disclosure in spray coating, a damage tolerant glass ceramic structure is formed. By tailoring the mix of primary particles of the agglomerates forming the mixture of primary particles, and heat treating these agglomerates to form the crystalline particles of the powder composition, a glass ceramic structure with desired proportions of glass and crystalline phases forms in-situ during thermal spraying. The formed glass ceramic coating is typically electrical and corrosion resistant and have good wear resistance.

A further advantage of the disclosure is the sustainability of the raw materials, since no critical or scarce materials are used.

### BRIEF DESCRIPTION OF THE DRAWINGS

In the following the disclosure will be described in greater detail by means of preferred embodiments with reference to the accompanying drawings, in which

FIG. 1 shows an illustration of an embodiment of the method of the disclosure;

FIG. 2A, B, C shows a X-ray diffraction analysis (XRD) graph for powder compositions of the disclosure;

FIG. 3A, B, C shows a XRD graph for test coatings No. 1-3 prepared from powder compositions of the disclosure;

FIG. 4 shows a XRD graph for comparative coatings No. 1A and 1B;

FIG. 5 shows a XRD graph for commercial comparative coating 4;

FIG. 6 shows a diagram of the results of the abrasion wear testing of different test coatings and comparative coatings;

FIG. 7 shows a Scanning Electron Microscopy (SEM) cross-section image of one crystalline particle of the powder composition of the disclosure; and

FIG. 8 shows a SEM image of crystalline particles of the powder composition of the disclosure.

### DETAILED DESCRIPTION OF THE DISCLOSURE

The disclosure relates to a method for providing a powder composition for glass ceramic coating. More in detail the method comprises preparing the powder composition by heat treating a mixture of primary particles agglomerates at a temperature between 90° and 1500° C. for between 30 min and 24 hours. Typically, the mixture of primary particles consists of between 35 and 60 mol-% cations and between 40 and 65 mol-% of anions, wherein the cations comprise between 1:3 and 1:40 of the total sum of Ca- and Si-ions (mol-%): Al-ions (mol-%). The primary particles typically have a particle size below 1 μm and the mixture of primary particles comprises agglomerates consisting of a mix of the primary particles.

According to embodiments of the disclosure a method for preparing a powder composition for glass ceramic coating is provided, wherein the method comprises providing a mixture of primary particles; wherein the mixture consists of between 35 and 60 mol-% cations and between 40 and 65 mol-% anions, preferably oxygen; the cations comprise between 1:3 and 1:40 of the sum of Ca- and Si-ions (mol-%): Al-ions (mol-%); the mixture comprises Ca-ions (mol-%): Si-ions (mol-%) in a ratio of 1:2.5-2.5:1; the mixture comprises agglomerates consisting of a mix of the primary particles; and the primary particles have a particle size below 1 μm; and thereby providing a powder composition by heat treating the agglomerates at a temperature between 90° and 1500° C. for between 30 minutes and 24 hours.

According to an embodiment of the disclosure the mixture of primary particles is provided by dispersing starting material(s), at least Al-, Ca- and Si-ions, to form a dispersion of separated primary particles; and drying, preferably spray-drying the dispersion, to provide agglomerates. O-ions are typically provided in the starting material as oxide(s) or hydroxide(s), but O-ions can also be bound from air, especially if the starting material(s) comprises oxide former(s). The agglomerates consist of a mix of the primary particles, typically a mix of all the different primary particles, essentially evenly distributed throughout the agglomerates. The dispersing is typically performed by a method which separates and/or disperses the primary particles, preferably a disperser or grinder, more preferably a bead mill or another grinding apparatus. During the dispersing, water and optionally also dispersing agent(s) and/or binder(s) are added to the starting material(s). Dispersing agent(s) are typically used in order to enhance dispersing by reducing viscosity, shortening dispersion time, avoiding flocculation and to stabilize the dispersion. Typically, the use of dispersing agent(s) enables maximum solid content of the dispersion whilst the viscosity of the dispersion is kept low enough to be sprayed by spray-drying. Any dispersing agent suitable for water-based systems and oxides can be used. Binder(s) typically helps to achieve the tackiness needed for a material to adhere to itself, i.e. to hinder the primary particle agglomerates to fall apart into primary particles after spray drying. Typically, water-soluble polymers, such as polyethylene glycol (PEG) or polyvinyl alcohol (PVA) and polyvinyl acetate (PVAc), are suitable binders. The spray-dying is typically performed by an apparatus producing agglomerates having a particle size between 5 and 50 μm, preferably between 10 and 35 μm, i.e. a particle size distribution suitable for thermal spraying. Typically, the spray-drying is performed at normal pressure and air atmospheric conditions. Spray drying is a commonly used method in industry wherein the particle suspension is sprayed with water or a solvent to a hot gas, which evaporates the liquid and dry primary particle agglomerates are collected.

The disclosure also relates to a powder composition obtained by the method of the disclosure and the use of the powder composition in thermal spraying to form a glass ceramic coating, the use of the powder composition for forming a glass ceramic structure in-situ in thermal spray deposition and the use of the powder composition for thermal spraying the powder composition on a substrate. The glass ceramic coating or the glass ceramic structure is used on different substrates, preferably on different metal surfaces, more preferably on paper machine rolls. Advantageously, the glass ceramic coating or the glass ceramic structure is used in automotive industry, in aerospace industry and/or in machine building, for example for electrical insulation or on paper machine rolls. The glass ceramic coating or the glass ceramic structure can be used in any industry for electrical insulation.

The powder composition obtained by the method of the disclosure is typically used in a method comprising thermal spraying of the powder composition on a substrate. A glass ceramic structure is formed in-situ in thermal spray deposition, wherein the glass ceramic structure comprises a glass phase and a crystalline phase. Typically, the glass ceramic structure consists of between 5 and 60 w-% glass phase and between 40 and 95 w-% crystalline phase, preferably between 20 and 40 w-% glass phase and between 60 and 80 W-% crystalline phase. Typically, the thermal spraying has a velocity over 200 m/s and a temperature over 1900° C., preferably over 2000° C.

The term “primary particle” as used herein means the small basic units of the different ions. The primary particles typically have a particle size below 1 μm, preferably the particle size of the primary particles is between 1 nm and 1 μm, more preferably between 10 nm and 200 nm and most preferably between 10 nm and 100 nm. Primary particles characteristically agglomerate to larger units called agglomerates by adhesion, i.e. by weak physical interactions.

The term “agglomerates” as used herein means an assembly of primary particles that have grown together and are aligned side by side, for example joined together at the corners or edges. The original geometry of the primary particles is still visible in the aggregate, the particles are firmly fused together. Agglomerates are not fixed units but could change their size and shape depending on the conditions. The density of agglomerates depends on the particle size distribution of the primary particles when the agglomerates have equal geometry and chemical composition.

The term “mixture of primary particles” as used herein means providing agglomerates consisting of a mix of primary particles, wherein the primary particles consisting of the different ions of the starting material(s) are mixed and essentially of the same, small size.

The starting material(s) may comprise one or more cation(s) and are typically provided as a different type of agglomerates comprising the same kind(s) of primary particles. Typically, the mixture of primary particles is prepared by dispersing starting material(s) comprising aluminium, calcium and silicate oxide(s) or hydroxide(s), water and optionally dispersing agent(s) and/or binder(s), to form a dispersion of separated primary particles and drying, preferably spray-drying the dispersion in order to form agglomerates consisting of a mix of the primary particles.

The term “particle size” as used herein for the size of the primary particles and the size of the agglomerates of the mixture of primary particles means that the particle size of essentially all individual particles is within the given particle size range. The particle size distribution is such that typically at most 10% of the total particles have a particle size smaller than the lower end of the range (D10 is the same or higher than the lower end of the claimed range) and/or at least 90% of the total particles are smaller than the higher end of the range (D90 is the same or lower than the higher end of the claimed range), preferably at least 80%, more preferably at least 90% of the total particles is within the given particle size range.

The terms “glass ceramic structure” and “glass ceramic coating” as used herein, refers to a material which consists of both crystalline ceramic and amorphous glass phase. The presence of an amorphous glass phase is typically indicated as a background hump (or bump) in the baseline in a X-ray diffraction analysis (XRD) graph, particularly in the low angle region, whereas sharp peaks indicate the presence of crystalline phase.

The term “powder composition for glass ceramic coating” as used to herein, refers to a composition of spray powder particles which have mechanical strength to withstand mechanical agitation during thermal spraying and have suitable particle size distribution for thermal spraying and thermal coating, typically a particle size between 5 μm and 50 μm.

The term “thermal spraying” as used herein refers to a group of coating processes in which finely divided materials are deposited in a molten or semi-molten condition to form a coating. Typically, the thermal spraying refers to thermal spraying processes where the process temperature is above 1900° C. and particle velocity is above 200 m/s, such as atmospheric plasma spraying, APS, high velocity oxygen fuel spraying, HVOF and high velocity air-fuel spraying, HVAF. Generally thermal spraying is a process where metals, ceramic, cermet and selected polymeric materials are fed in the form of powder, wire and rods to a torch where the materials are heated or melted and accelerated in the gas stream towards a substrate where they form splats which form the coating. Thermal spray processes are typically classified according to the type of energy source used to melt the feedstock material. Rapid particle cooling rates and the lamellar splat shapes are two features that distinguish thermal spray coatings from other coatings. In plasma spraying, plasma forming gases (which are usually a mixture of either argon/hydrogen or argon/helium) pass between two electrodes, the gases are heated by the arc, then expanded, and finally accelerated through a nozzle, developing particle velocities over 500 m/s and temperatures over 10000° C. The powder of the coating material and carrier gas are fed into the exit point of the nozzle, which is the heating zone, through an inlet to become molten. Melted particles are then forced out from the nozzle and projected toward the substrate allowing them to form a coating layer. HVOF coating is a thermal spray process in which a fuel (typically propane, kerosene or hydrogen) and oxygen are mixed, fed into a combustion chamber, and ignited. The gas produced in the combustion chamber has a temperature up to 3100° C. and is ejected through a nozzle with a particle velocity of about 500-1000 m/s. In HVAF spraying the feedstock powder is melted just above the melting temperature of the material, typically the temperature is 1900-1950° C. and the particle velocity is typically above 1000 m/s. Plasma spray is typically faster and more suitable for high melting materials, whereas HVOF and HVAF methods are more suitable for materials melting at lower temperatures. Although the temperature used in vacuum plasma spraying, VPS is lower, vacuum plasma spraying can also be used as the thermal spraying method.

In embodiments of the disclosure the mixture of primary particles typically consists of between 35 and 60 mol-% cations and between 40 and 65 mol-% anions, preferably oxygen in the form of oxide(s) and hydroxide(s). Preferably the amount of cations is between 35 and 45 mol-% and the amount of anions between 55 and 65 mol-%, counted based on the Al-, Ca- and Si-ions of the starting material(s) and the mol-% of Al-, Ca- and Si- and O-ions of the corresponding Al-, Ca- and Si-oxides, without taking into account possible superfluous amounts of O-ions of the starting material(s). Typically, between 80 and 100 mol-% of the anions are oxygen, preferably between 85 and 99 mol-%, more preferably between 90 and 99 mol-%, including the amount of oxygen being between two of the following: 80, 85, 90, 95, 98, 99 and 100 mol-% of the total amount of anions. The primary particles typically have a particle size below 1 μm. Preferably the particle size of the primary particles is between 1 nm and 1 μm, more preferably between 10 nm and 200 nm and most preferably between 10 nm and 100 nm. The mixture of primary particles comprises agglomerates consisting of a mix of the primary particles typically comprising at least Al, Ca-, Si- and O-ions. It is believed that the small size of the primary particles as well as the mix of essentially evenly distributed defined ratios of different primary particles throughout the agglomerates causes the reactions between the primary particles which leads to the glass ceramic coating powder composition that forms crystalline ceramic and amorphous glass phases during thermal spaying. Preferably the size of the agglomerates is between 5 μm and 50 μm, more preferably between 10 μm and 35 μm, most preferably between 10 μm and 25 μm. Typically, the total sum of Ca- and Si-ions (mol-%): Al-ions (mol-%) is between 1:3 and 1:40 of (mol-%), preferably between 1:5 and 1:25, more preferably between 1:8 and 1:20. If one of Ca- and Si-ions is missing, the other forms the total sum alone as compared to mol-% of Al-ions, preferably the mixture of primary particle comprises Ca-, Si- and Al-cations. The ratio of Ca-ions (mol-%): Si-ions (mol-%) is typically between 1:2.5 and 2.5:1, preferably between 1:1.9 and 2.2:1, more preferably between 1:1.2 and 1.2:1 in the mixture of primary particles. Typically, the cations of the mixture of primary particles essentially consists of Al, Ca- and Si-ions, preferably over 75 mol-%, more preferably over 85 mol-%, most preferably over 95 mol-% of the cations are Al, Ca- and Si-ions. In some embodiments of the disclosure the cations further comprise one or more other cations, preferably chosen from one or more of Zn-, Cu-, Zr-, Mg-, Fe-, K-, Na-, Li-, Ti- and B-ions. The single agglomerates of the mixture of primary particles typically comprises essentially the same ratios of cations as the total mixture of primary particles. Typically, also the powder particles of the powder composition as well as the coatings prepared by thermal spaying of the powder composition comprises essentially the same ratios of cations as the agglomerates and the total mixture of primary particles.

In embodiments of the disclosure the powder composition is provided by heat treating the agglomerates of the mixture of primary particles at a temperature between 90° and 1500° C., preferably between 100° and 1350° C., more preferably between 120° and 1300° C., including the temperature being a temperature between two of the following temperatures; 900° C., 950° C., 1000° C., 1050° C., 1100° C., 1150° C., 1200° C., 1250° C., 1300° C., 1350° C., 1400° C., 1450° C. and 1500° C. for between 30 minutes and 24 hours, preferably between 30 minutes and 10 hours, more preferably between 1 and 5 hours, most preferably between 1.5 and 3 hours, including the time being between two of the following; 30 minutes, 40 minutes, 50 minutes, 60 minutes, 90 minutes, 2 h, 3 h, 4 h, 5 h, 6 h, 7 h, 8 h, 10 h, 15 h, 20 h and 24 h. During the heat treating, there is typically water removal, calcination of the primary particles as well as partly sintering of the agglomerates. By the heat treating of the disclosure, the agglomerate strength is increased enough to enable handling of the crystalline particles formed but avoiding agglomerates and/or particles to stick together. The formed powder composition comprises or consists of crystalline powder particles which are essentially of the same size as the agglomerates and essentially spherical. The heat-treated particles typically have a porosity below 60 vol-%, preferably below 50 vol-%. The heat treating is typically performed under normal pressure and standard air atmospheric conditions.

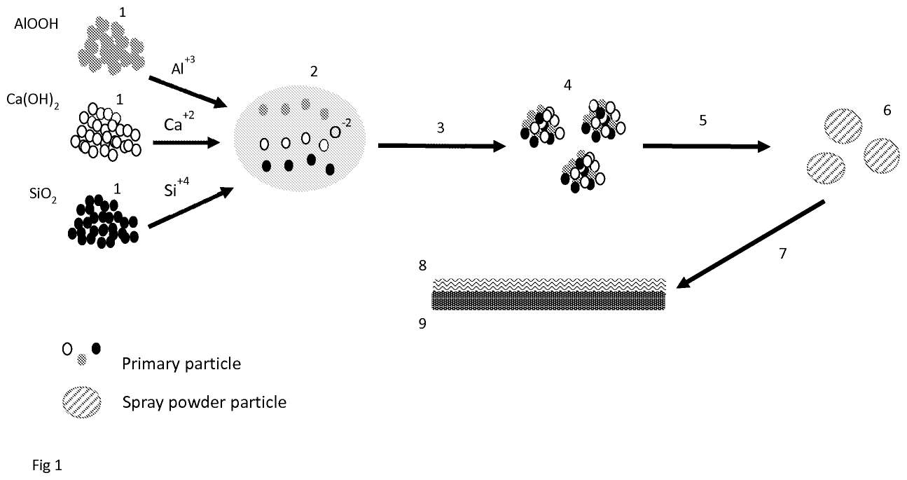

FIG. 1 shows an embodiment of the method of the disclosure. Starting materials (1), for example AlOOH, Ca(OH)₂ and SiO₂ comprising Al-, Ca- and Si-cations, as well as O-anions, are mixed to form a dispersion (2) of separated primary particles. During the dispersing, water and optionally also dispersing agent(s) and/or binder(s) are added to the starting materials (not shown). The dispersion is spray-dried (3) to provide agglomerates (4), consisting of a mix of the different primary particles. The agglomerates (4) are heat treated (5) at a temperature between 90° and 1500° C. for between 30 min and 24 hours to provide spray powder particles (6). A coating (8) consisting of glass phase and crystalline phase is obtained by thermal spraying (7) the powder composition (6) on a substrate (9).

### EXAMPLES

### Example 1 Preparing Mixture of Primary Particles

The amounts (g) of AlOOH, Ca(OH)₂ and SiO₂ specified in Table 1 were mixed in a bead mill together with 50 w-% of water for 30 minutes. 2 w-% binder (polyethylene glycol, PEG) and 1 w-% of a dispersing agent chosen from the group consisting of dispersing agent(s) of ammonium salt of an acrylic polymer (DISPEX A40) were added (of the dry weight). The formed dispersion of primary particles with a particle size between 5 nm and 1 μm was spray-dried to remove water. The formed agglomerates had a particle size distribution D50 18 μm and D90 32 μm and consisted of a mix of primary particles.

TABLE 1
Amounts of starting materials (g)

| | | | |
|---|---|---|---|
| Test No. | AlOOH | Ca(OH)2 | SiO2 |

| | | | | |
|---|---|---|---|---|
| 1 | PL11, PLAS 11 | 76.0 | 11.0 | 13.0 |
| 2 | PL14, PLAS 14 | 88.0 | 5.5 | 6.5 |
| 3 | PL20, PLAS 17 | 93.9 | 4.1 | 2.0 |
| Comp 1A | PL4, PLAS09 | 51.0 | 23.0 | 26.0 |
| Comp 1B | PL5, PLAS10 | 50.0 | 33.5 | 16.5 |

In Table 2 the mol-% of Al-, Ca-, Si- and O-ions were counted based on Al-, Ca- and Si-ions in the starting materials and the mol-% of Al-, Ca-, Si- and O-ions of the corresponding Al-, Ca- and Si-oxides. Possible superfluous amounts of O-ions of the starting materials were not taken into account.

The ratios of Al, Ca- and Si-ions in the mixture of primary particles shown in Table 3 were counted from the mol-% shown in Table 2.

TABLE 2
Counted amounts of ions (mol-%)

| Test No. | Al | Ca | Si | O |
|---|---|---|---|---|
| 1 | 30.8 | 3.7 | 5.2 | 60.3 |
| 2 | 35.5 | 1.5 | 2.7 | 60.3 |
| 3 | 38.0 | 1.5 | 0.7 | 59.8 |
| Comp 1A | 21.0 | 7.6 | 10.7 | 60.6 |
| Comp 1B | 21.7 | 11.8 | 7.4 | 59.1 |

TABLE 3
Ratios of ions in the mixture of primary particles

| | (Ca-ions + Si- | Ca-ions:Si - |
|---|---|---|
| Test No. | ions):Al-ions (mol-%) | ions (mol-%) |
| 1 | 1:3.5 | 1:1.4 |
| 2 | 1:8.5 | 1:1.8 |
| 3 | 1:17 | 2.1:1 |
| Comp 1A | 1:1.1 | 1:1.4 |
| Comp 1B | 1:1.1 | 1.6:1 |

### Example 2 Preparing Powder Compositions

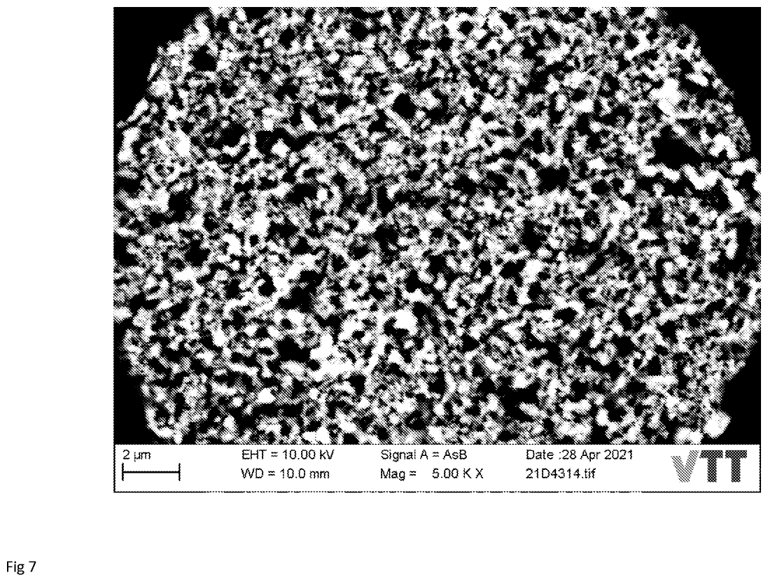

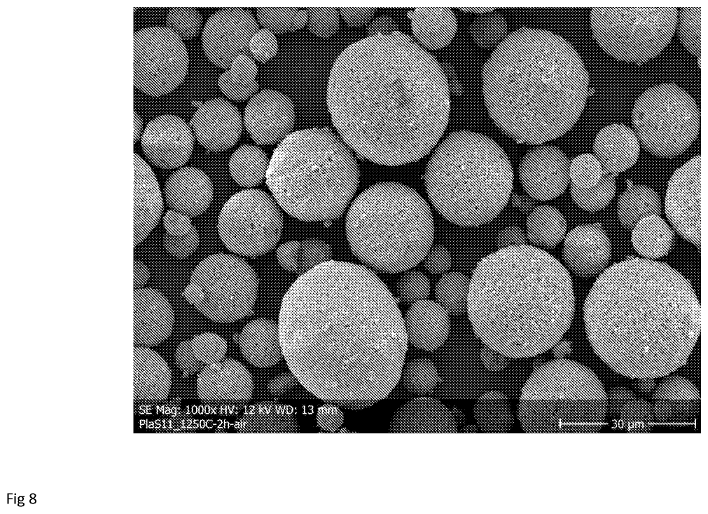

The spray dried agglomerates of Example 1 were heat treated in an electric air furnace at a temperature of 1250° C. for 2 hours. The resulted crystalline particles with about 50% porosity had a mix of different primary particles as can be seen from the Scanning Electron Microscopy (SEM) in FIG. 7, the cross-section of one crystalline particle of the powder composition of test 1. As seen from the SEM image in FIG. 8, showing crystalline particles of the powder composition of test 1, the crystalline powder particles are essentially spherical, and the size is mostly between about 5 μm and about 25 μm (D10 10 μm, D50 20 μm, D90 35 μm). The crystalline particles of the powder composition had essentially the same ratios of cations as the agglomerates.

### Example 3 Preparing Coatings

The powder compositions obtained in Example 2 were sprayed on a AISI 304 steel substrate using a Oerlikon Metco F4 plasma gun, i.e. atmospheric plasma spraying.

### Example 4 XRD of Powder Composition

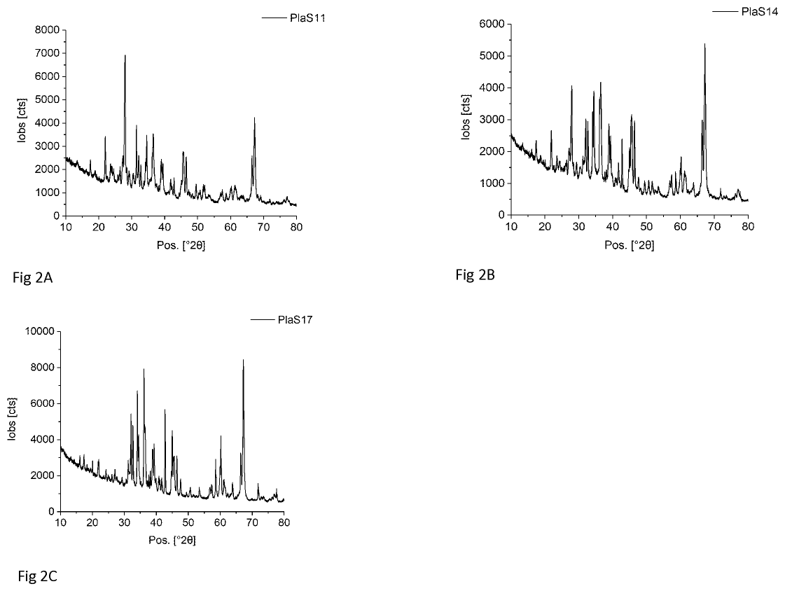

X-ray diffraction analysis (XRD) was used to determine the crystallographic structure of the powder compositions of Example 2. Qualitative phase analyses were carried out by an X-ray diffractometer (XRD, Empyrean, PANalytical B.V.) with Cu-Kα radiation source and analyzed using the High Score Plus software with the ICDD crystallographic database. The results for the powder compositions of tests 1-3 are shown in FIG. 2A-C.

The XRD graphs indicate that the powder compositions comprise no amorphous glass phase, since the graph shows no hump in the low angle region.

### Example 5 XRD of Coatings

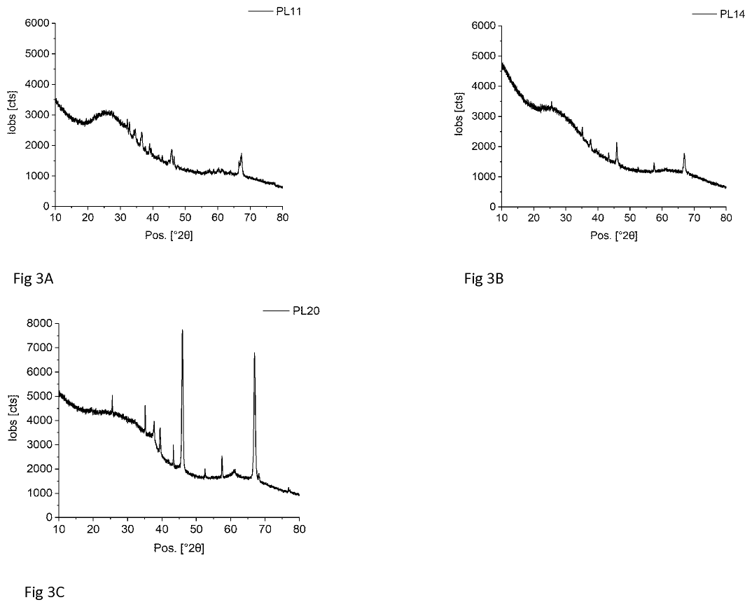

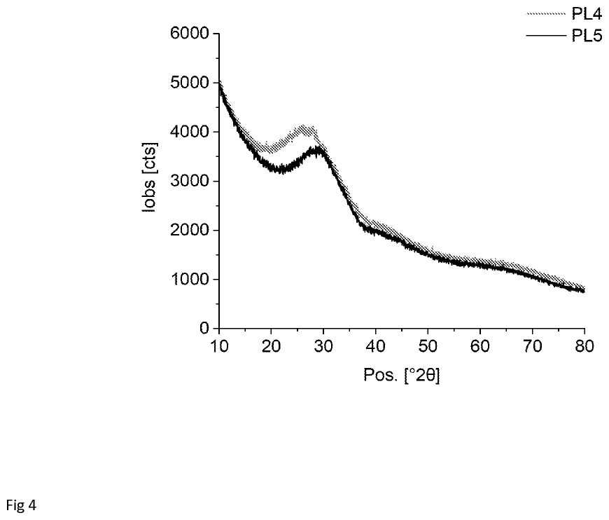

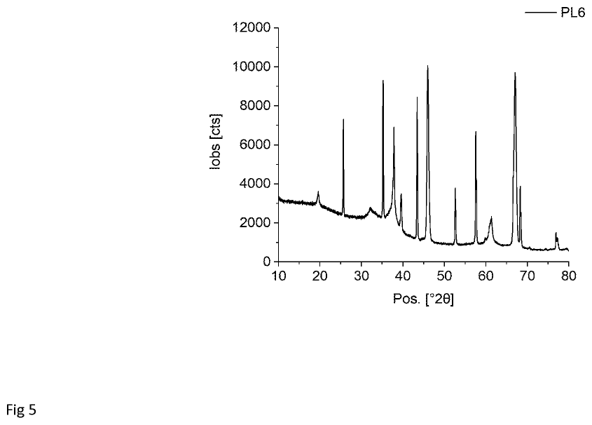

X-ray diffraction analysis (XRD) was used to determine the crystallographic structure of the coatings of Example 3. Qualitative phase analyses were carried out by an X-ray diffractometer (XRD, Empyrean, PANalytical B.V.) with Cu-Kα radiation source and analyzed using the HighScore Plus software with the ICDD crystallographic database. The results are shown in FIG. 3A-C for the coatings of tests 1-3 and in FIG. 4 for Comparative tests 1A and 1B. FIG. 5 shows the XRD for the commercial comparative coating No. 4 (see Table 4, Comp 4).

As shown in FIG. 4, the crystalline ceramic phase is missing from the comparative example No. 1A and 1B, as the graph only shows a hump in the low angle region and no peaks. As shown in FIG. 5, the amorphous glass phase is missing for comparative test No. 4 since the graph shows no hump in the low angle region.

As shown in FIG. 3A-C, test coatings 1-3 have both amorphous glass phase, indicated by the hump in Position 15-40° 2θ as well as ceramic crystalline phase, indicated by the sharp peaks.

### Example 6 Abrasion Wear Testing of Coatings

The coatings obtained in Example 3 were tested for abrasion wear resistance by rubber wheel abrasion carried out applying standard ASTM G65. The sand flow was 360 g/min. The test duration was 10 minutes except for comparative test 1 (Comp 1, 5 minutes).

TABLE 4
Weight loss of the coatings of the disclosure

| Tests No. | Weight loss (g) |
|---|---|
| 1 | 0.0876 |
| 2 | 0.0248 |
| 3 | 0.0202 |
| Comp 1A | 0.125 (5 minutes) |

TABLE 5
Weight loss of commercial comparative coatings

| Compartive | | | | Weight |
|---|---|---|---|---|
| tests No. | | | | loss (g) |
| Comp 2 | PL1 | Amperit 740 | Al₂O₃ | 0.1248 |
| Comp 3 | PL2 | Amperit 746.3 | Al₂O₃—40TiO₂ | 0.0329 |
| Comp 4 | PL6 | Metco 6103 | Al₂O₃ | 0.0972 |

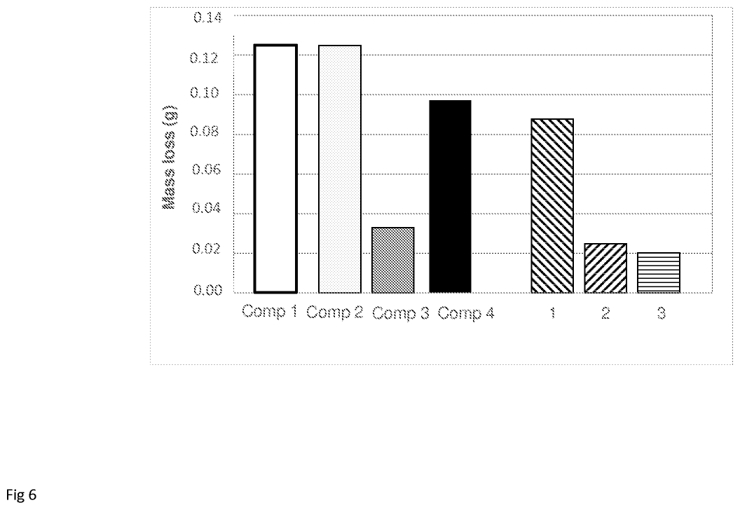

As can be seen from the results in Table 4 and Table 5 and from FIG. 6, the weight loss of the coating of comparative test 1A (Comp 1A) comprising only amorphous glass phase is higher than for the commercial coatings, whereas the wear resistance of the other tested coatings is better than for the commercial coatings comprising only Al₂O₃, and as good or better than the comparative coating No. 3 of a commercial coating comprising TiO₂, without using scarce or expensive materials as starting materials. As shown, the tested coatings 1-3, especially coatings 2-3 are especially suitable for demanding applications where high wear resistance of the coatings are needed, such as on paper machine rolls

1. A method for preparing a powder composition for glass ceramic coating, the method comprising
providing a mixture of primary particles, wherein
the mixture consists of between 35 and 60 mol-% cations and between 40 and 65 mol-% anions, preferably oxygen,
the cations comprise between 1:3 and 1:40 of the sum of Ca- and Si-ions (mol-%): Al-ions (mol-%),
the mixture comprises Ca-ions (mol-%): Si-ions (mol-%) in a ratio of 1:2.5-2.5:1,
the mixture comprises agglomerates consisting of a mix of the primary particles, and
the primary particles have a particle size below 1 μm; and
providing a powder composition by heat treating the agglomerates at a temperature between 90° and 1500° C. for between 30 minutes and 24 hours.

2. The method according to claim 1, wherein the mixture of primary particles is provided by dispersing starting material(s) comprising Al-, Ca- and Si-ions, to form a dispersion of separated primary particles; and by drying, preferably spray-drying the dispersion.

3. The method according to claim 2, wherein the dispersing is performed by a method which separates the primary particles, preferably a disperser or grinder, more preferably a bead mill.

4. The method according to claim 2, wherein the agglomerates provided by the spray-drying, have a particle size between 5 and 50 μm, preferably between 10 and 35 μm.

5. The method according to claim 1, wherein during the heat treating, the agglomerates are calcinated to form powder particles.

6. The method according to claim 1, wherein the powder particles of the powder composition have a porosity below 60 vol-%, preferably below 50 vol-%.

7. The method according to claim 1, wherein the particle size of the primary particles is between 1 nm and 1 μm, preferably between 10 nm and 200 nm, more preferably between 10 nm and 100 nm.

8. The method according to any claim 1, wherein the cations further comprises one or more of Zn-, Cu-, Zr-, Mg-, Fe-K-, Na-, Li-, Ti- and B-ions.

9. The method according to claim 1, wherein the mixture of primary particles comprises Ca-ions (mol-%): Si-ions (mol-%) in a ratio of 1:1.9-2.2:1, preferably 1:1.2-1.2:1.

10. The method according to claim 1, wherein the powder composition is provided by treating the mixture of primary particles at a temperature between 100° and 1350° C., preferably between 120° and 1300° C., for between 30 minutes and 10 hours, preferably between 1 and 5 hours, more preferably between 1.5 and 3 hours.

11. A powder composition obtained by the method according to claim 1.

12. Use of a powder composition according to claim 11 in thermal spraying to form a glass ceramic coating.

13. Use of a powder composition according to claim 11 for forming a glass ceramic structure in-situ in thermal spray deposition.

14. The use of claim 12, wherein the thermal spraying has a velocity over 200 m/s and a temperature over 1900° C.

15. Use of the glass ceramic coating of claim 11, in automotive industry, in aerospace industry, and/or in machine building, such as for electrical insulation or on paper machine rolls.

16. Use of the glass ceramic structure of claim 13, in the automotive industry, in aerospace industry or machine building, such as for electrical insulation or on paper machine rolls.
